(19) United States
(12) Patent Application Publication
(10) Pub. No.: US 2014/0318910 A1
(43) Pub. Date: Oct. 30, 2014

(54) BRAKE SYSTEM FOR A VEHICLE AND METHOD FOR OPERATING A BRAKE SYSTEM OF A VEHICLE

(71) Applicants: Frank Kaestner, Bietigheim-Bissingen (DE); Michael Kunz, Steinheim An Der Murr (DE); Rene Schepp, Waiblingen (DE); Norbert Alaze, Markgroeningen (DE)

(72) Inventors: Frank Kaestner, Bietigheim-Bissingen (DE); Michael Kunz, Steinheim An Der Murr (DE); Rene Schepp, Waiblingen (DE); Norbert Alaze, Markgroeningen (DE)

(21) Appl. No.: 14/235,264

(22) PCT Filed: May 29, 2012
(86) PCT No.: PCT/EP2012/060010

§ 371 Date: May 8, 2014

(30) Foreign Application Priority Data
Jul. 26, 2011 (DE) 10 2011 079 862.5

(51) Int. Cl. B60T 13/18

(52) U.S. Cl. CPC B60T 13/18
USPC 188/355

(57) ABSTRACT

A brake system is described for a vehicle having a master brake cylinder that is hydraulically connected to at least one wheel brake caliper, and having a fluid conveyor device by which brake fluid can be transferred into the at least one wheel brake caliper and out of the at least one wheel brake caliper, the fluid conveyor device including a pump motor that is controllable in two directions of rotation, the motor being capable of being controlled in such a way that brake fluid can optionally be pumped by the fluid conveyor device either out of a fluid storage device into the at least one wheel brake caliper or out of the at least one wheel brake caliper into the fluid storage device. In addition, also described is a method for operating a brake system of a vehicle.

### FIELD OF THE INVENTION

The present invention relates to a brake system for a vehicle. In addition, the present invention relates to a method for operating a brake system of a vehicle.

### BACKGROUND INFORMATION

European Published Patent Appln. No. 0 565 153 describes a plunger device fashioned as an anti-slippage regulator. By means of the anti-slippage regulator, a volume of brake fluid can be suctioned from a wheel brake caliper into a fluid storage volume of the anti-slippage regulator in order to reduce a brake pressure in the wheel brake caliper. Likewise, a brake fluid volume can be pressed out of the fluid storage volume of the anti-slippage regulator into the wheel brake caliper in order to increase the brake pressure.

### SUMMARY

The present invention creates a brake system for a vehicle and a method for operating a brake system of a vehicle.

The present invention enables a brake system having a fluid conveyor device for increasing and for reducing a brake pressure present in the at least one wheel brake caliper, independent of an internal pressure present in a hydraulic cylinder, the fluid conveyor device having a comparatively small constructive size, and being capable of being assembled with a low assembly outlay and of being manufactured at low cost. The fluid conveyor device, having the pump motor controllable in two directions of rotation, is therefore an advantageous recuperation unit/masking unit.

In comparison with a plunger, the fluid conveying device does not require an expensive gear mechanism such as a spindle drive. The energy consumption of the fluid conveyor device, having the pump motor controllable in two directions of rotation, is comparatively low due to the lack of frictional losses that would occur for example in the case of a plunger. The present invention therefore also ensures a reduction in energy consumption, and a reduction in fuel emission of a vehicle equipped with the brake system. Moreover, the fluid conveyor device does not require the comparatively large transmission ratio of a plunger.

Through the design of the fluid conveying device for the optional pumping of brake fluid from the fluid storage device into the at least one wheel brake caliper or from the at least one wheel brake caliper into the fluid storage device, it is not only possible advantageously to increase the brake pressure in the at least one wheel brake caliper, but also to dismantle this brake pressure (almost) completely. Thus, the present invention offers an advantageous possibility for the complete dismantling of a brake pressure in at least one wheel brake caliper. Interaction of a further component of the brake system, such as at least one check valve, with the fluid conveyor device during the modification of the brake pressure is not necessary. Thus, using the fluid conveyor device having the pump motor controllable in two directions of rotation, other components, such as check valves, can be saved.

In an advantageous specific embodiment, the fluid conveyor device, including the pump motor controllable in two directions of rotation, is fashioned as a gear pump. The gear pump is a particularly energy-efficient possible realization of the advantageous fluid conveyor device.

In particular, the fluid conveyor device having the pump motor controllable in the two directions of rotation can be fashioned as an internal gear pump. In this case, the optional conveying of brake fluid from the fluid storage device into the at least one wheel brake caliper or from the at least one wheel brake caliper into the fluid storage device can be carried out reliably. Instead of an internal gear pump, however, an external gear pump can also be used for this purpose.

Preferably, the fluid conveyor device is hydraulically connected to the at least one wheel brake caliper or to the fluid storage device via an inlet and outlet control valve. By closing the inlet and outlet control valve, in this case an undesirable seepage of brake fluid through the fluid conveyor device, not in operation, can reliably be prevented.

In a further advantageous specific embodiment, the fluid conveyor device is a storage chamber not having a spring. This chamber can be understood for example as a storage chamber that is not spring-loaded. By fashioning the storage chamber without a spring, an additional reset spring on the storage piston can be saved.

Likewise, the fluid conveyor device can be connected to a brake fluid reservoir via a connecting line. In this way, the fluid storage device can be fashioned without counterpressure, which reduces the energy that has to be applied by the fluid conveyor device in order to transfer brake fluid into the fluid storage device.

Preferably, the fluid conveyor device is a membrane storage device that is not prestressed by gas. In this way, it can be prevented that, when the previously accommodated brake fluid is pumped into the at least one wheel brake caliper, there results a partial vacuum at the intake side of the fluid conveying device that would pull a storage chamber piston up to its end stop.

In an advantageous development, the brake system can include a control device that is designed to determine, taking into account a provided item of information relating to a temporally varying non-hydraulic additional braking moment, a target direction of rotation, a target rotational speed, and/or a target duration of rotation of the pump motor of the fluid conveyor device, and to output to the pump motor a pump control signal corresponding to the determined target direction of rotation, the determined target rotational speed, and/or the determined target duration of rotation. In this case, the fluid conveyor device and the control device can be used to set the brake pressure in the at least one wheel brake caliper in such a way that an overall braking moment specified by the driver can be reliably maintained despite a varying of the non-hydraulic additional braking moment. In particular, a generator braking moment that varies with time can in this way be masked in such a way that the driver does not notice an activation or a deactivation of the operation of the generator.

The advantages described above are also ensured in a corresponding method for operating a brake system of a vehicle.

Advantageously, a target direction of rotation, a target rotational speed, and/or a target duration of rotation of the pump motor of the fluid conveyor device can be determined taking into account a temporally varying non-hydraulic additional braking moment, and the pump motor of the fluid conveyor device can be operated in a manner corresponding to the determined target direction of rotation, the determined target rotational speed, and/or the determined target duration of rotation. The method according to the present invention can therefore also be used for the masking of a non-hydraulic additional braking moment, such as in particular a generator braking moment.

### BRIEF DESCRIPTION OF THE DRAWINGS

FIG. 1 shows a schematic representation of a specific embodiment of the brake system.

FIG. 2 shows a flow diagram representing a specific embodiment of the method for operating a brake system of a vehicle.

### DETAILED DESCRIPTION

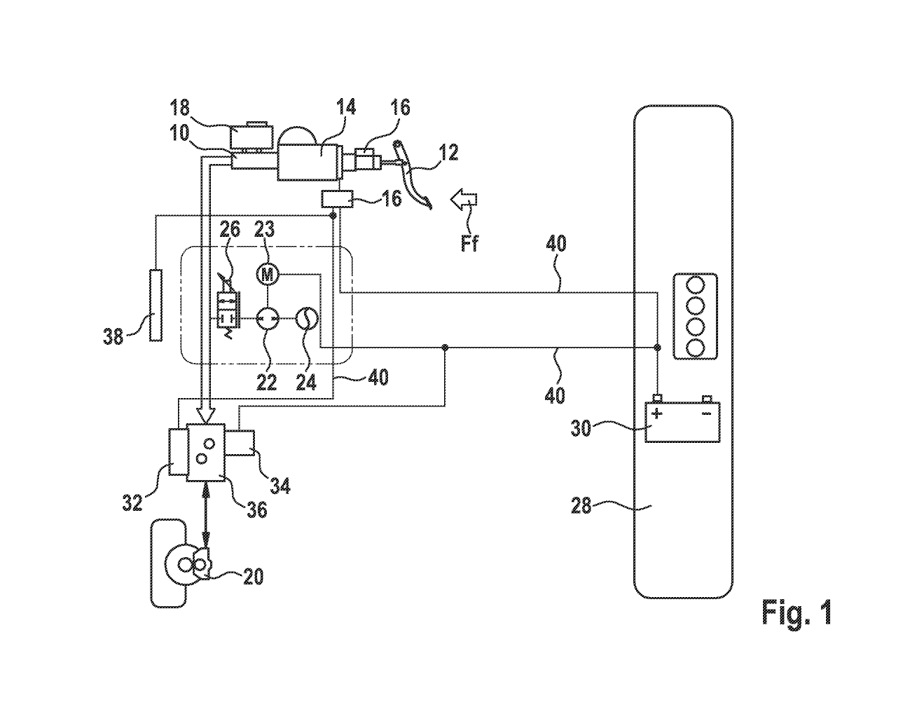

FIG. 1 shows a schematic representation of a specific embodiment of the brake system.

The brake system shown schematically in FIG. 1 includes a master brake cylinder 10 that is for example fashioned as a tandem master brake cylinder. The brake system for a vehicle described in the following is however not limited to being equipped with a master brake cylinder 10 fashioned as a tandem master brake cylinder.

Preferably, a brake actuating element 12 is situated on master brake cylinder 10 in such a way that a driver of a vehicle equipped with the brake system can use a driver braking force Ff applied to brake actuating element 12 to displace at least one displaceable piston of master brake cylinder 10, such as for example a rod piston and/or a floating piston, into the cylinder. Brake actuating element 12 can in particular be fashioned as a brake pedal. However, the brake system described below is not limited to being equipped with a brake actuating element 12 fashioned as a brake pedal or to being equipped with brake actuating element 12.

Optionally, the brake system also has a brake booster 14 that is designed to exert an additional (to the driver's braking force Ff) supporting force on the at least one displaceable piston of master brake cylinder 10 when there is an actuation of brake actuating element 12. In this way, when braking the vehicle the driver can be provided relief in terms of force. Brake booster 14 can for example be a hydraulic brake booster and/or an electromechanical brake booster. Advantageously, brake booster 14 is fashioned as a continuously regulable/controllable brake booster. However, the realization of brake booster 14 is not limited to the examples enumerated here.

The brake system can also include at least one sensor 16 that is designed to determine an actuating strength of the actuation of brake actuating element 12 by the driver and to output a corresponding sensor signal. The at least one sensor 16 can for example be designed to determine the driver's braking force Ff, a displacement path of brake actuating element 12, and/or a brake pressure. The at least one sensor 16 can in particular be a rod path sensor or a brake pressure sensor. However, the realization of the at least one sensor 16 is not limited to the examples described here.

A brake fluid reservoir 18 (supply container) can also be situated on master brake cylinder 10. Brake fluid reservoir 18 can in particular be connected (hydraulically) to master brake cylinder 10 via at least one fluid exchange opening, such as a compensating bore. Preferably, brake fluid reservoir 18 is fashioned such that atmospheric pressure is (constantly) present in brake fluid reservoir 18 independent of an internal pressure in master brake cylinder 10.

Master brake cylinder 10 is hydraulically connected to at least one wheel brake caliper 20. A state of hydraulic connection can be understood as meaning that a brake fluid transfer between the two components hydraulically connected to one another is ensured (at least given the presence of at least one valve, in a particular state, that may be situated between the components). A hydraulic connection of master brake cylinder 10 to the at least one wheel brake caliper 20 can be understood in particular as meaning that the driver can, via an at least partial inward displacement of the at least one displaceable piston into master brake cylinder 10, transfer brake fluid from master brake cylinder 10 into the at least one wheel brake caliper. Thus, via an actuation of brake actuating element 12 the driver can build up a brake pressure in the at least one wheel brake caliper 20 in order to exert a hydraulic braking moment on the at least one associated wheel.

The brake system can in particular have four wheel brake calipers 20, each assigned to a respective wheel of the vehicle. However, it is to be noted that the brake system described here is not limited to being equipped with a particular number of wheel brake calipers 20. Thus, the brake system can also be fashioned for the braking of a vehicle having more than four wheels.

The brake system also has a fluid conveyor device 22 by which brake fluid can be transferred into the at least one wheel brake caliper 20 and out of the at least one wheel brake caliper 20. Fluid conveyor device 22 includes a pump motor 23 that can be controlled in two directions of rotation and that is capable of being controlled in such a way that brake fluid can optionally be pumped, by fluid conveyor device 22, either from a fluid storage device 24 into the at least one wheel brake caliper 20 or from the at least one wheel brake caliper 20 into fluid storage device 24. For this purpose, fluid conveyor device 22 is hydraulically connected at one side to fluid storage device 24, and is hydraulically connected at another side to the at least one wheel brake caliper 20.

Thus, fluid conveyor device 22 can pump additional brake fluid, in addition to the brake fluid transferred from master brake cylinder 10, into the at least one wheel brake caliper 20. Through the equipping of the brake system with fluid conveyor device 22, the brake pressure in the at least one wheel brake caliper can therefore be increased to a level greater than the brake pressure built up by the driver's braking force Ff. This can be used for example for a faster braking of the vehicle. Likewise, the brake pressure in the at least one wheel brake caliper 20 can be reduced using fluid conveyor device 22.

Through the advantageous equipping of the brake system with the fluid conveyor device, the brake pressure in the at least one wheel brake caliper 20 can (independent of an internal pressure present in master brake cylinder 10) optionally be held constant, reduced, or increased. This can also be described by saying that the brake pressure in the at least one wheel brake caliper 20 can be adjusted independently of the driver's braking force Ff exerted on brake actuating element 12. Fluid conveyor device 22 can thus also be used as a masking device by which the hydraulic braking moment of the at least one wheel brake caliper 20 can be adapted to a non-hydraulic additional braking moment, such as a generator braking moment. As is stated more precisely below, fluid conveyor device 22 is particularly suitable for masking a generator braking moment that varies with time. However, it is to be noted that the applicability of fluid conveyor device 22 is not limited to a masking of a generator braking moment.

Fluid conveyor device 22, equipped with pump motor 23 controllable in two directions of rotation, has a significantly reduced constructive size, compared to a plunger. Fluid conveyor device 22 is moreover capable of being operated without frictional losses, so that energy consumption and pollutant emission can be reduced in the vehicle equipped with the brake system. Moreover, fluid conveyor device 22 does not require an expensive gear mechanism, so that as a rule it can be manufactured at lower cost than a plunger.

Fluid conveyor device 22, having pump motor 23 controllable in two directions of rotation, can for example be fashioned as a gear pump. Through the realization of fluid conveyor device 22 as a gear pump, pulsations that occur during the transfer of brake fluid from fluid storage device 24 into the at least one wheel brake caliper 20, or during the transfer of brake fluid from the at least one wheel brake caliper 20 into fluid storage device 24, can be kept low/small. In this way, the driver can be prevented from noticing a vibration or shaking of brake actuating element 12 caused by large pulsations during actuation of brake actuating element 12. Thus, through the reduction/prevention of the pulsations, a pleasant brake actuation feeling can be realized for the driver. Moreover, the use of fluid conveyor device 22, fashioned as a gear pump, enables a significant reduction in irregularities in the moment, so that structure-borne sound can be reduced.

Preferably, fluid conveyor device 22 having the pump motor 23 controllable in two directions of rotation is fashioned as an internal gear pump. Fluid conveyor device 22 fashioned as an internal gear pump can be operated using a pump motor 23 that is inexpensive and takes up little constructive space. However, it is to be noted that the realization of the brake system is not limited to a use of a particular pump type as fluid conveyor device 22 having the pump motor 23 controllable in two directions of rotation. For example, instead of an internal gear pump for forward and backward running, an external gear pump for forward and backward running may also be used.

Optionally, fluid conveyor device 22 can be hydraulically connected to the at least one wheel brake caliper 20 (or to fluid storage device 24) via an inlet and outlet control valve 26. By equipping of the brake system with inlet and outlet control valve 26, an undesirable seepage of brake fluid through the non-actuated fluid conveyor device 22 can be reliably prevented. In a low-cost specific embodiment, inlet and outlet control valve 26 can be a switching valve. Alternatively, a continuously adjustable/regulable/controllable valve can be used as inlet and outlet control valve 26. Preferably, inlet and outlet control valve 26 is fashioned as a valve that is closed in the currentless state. Because in this case a flow to inlet and outlet control valve 26 is necessary only for controlling inlet and outlet control valve 26 into the at least partly open state, the realization of inlet and outlet control valve 26 as a valve that is closed in the currentless state can save energy.

However, the brake system described here is not limited to an equipping with inlet and outlet control valve 26. In particular in a realization of fluid conveyor device 22 that prevents the undesirable seepage of brake fluid through non-actuated fluid conveyor device 22, inlet and outlet control valve 26 can be omitted.

The brake system described here can be used advantageously in particular in a vehicle that, in addition to an internal combustion engine 28, also has a generator (not shown) for charging a vehicle battery 30. However, the applicability of the brake system is not limited to a vehicle equipped with the generator.

The brake system can also be equipped with an ESP device 32 that is designed to control the (not shown) high-pressure switching valves, changeover valves, wheel inlet valves, and/or wheel outlet valves of the at least one brake circuit. Likewise, the brake system can be designed to execute an ABS function. ESP device 32 can include a motor 34 and a hydraulic unit 36. However, because the realization of the brake system is not limited to a particular type of ESP device 32 or of the at least one brake circuit, these are not described in more detail here.

In an advantageous development, the brake system has a control device 38 that is designed to control fluid conveyor device 22 and/or continuously regulable outlet valve 26 in order to mask a temporally varying non-hydraulic additional braking moment, such as the generator braking moment of the generator. Control device 38 can be connected via lines 40 to the at least one sensor 16, pump motor 23, continuously regulable outlet valve 26, the generator, vehicle battery 30, and/or ESP device 32.

In an advantageous specific embodiment, control device 38 is designed to determine, taking into account a provided item of information relating to a temporally varying non-hydraulic additional braking moment, a target direction of rotation, a target rotational speed, and/or a target duration of rotation of pump motor 23 of fluid conveyor device 22, and to output to pump motor 23 a pump brake control signal corresponding to the determined target direction of rotation, target rotational speed, and/or target duration of rotation. In particular, when there is an increase over time of the non-hydraulic additional braking moment, especially an increase over time of a generator braking moment, the target direction of rotation of pump motor 23 can be determined such that, using fluid conveyor device 22, brake fluid can be pumped from the at least one wheel brake caliper 20 into fluid storage device 24. Correspondingly, when there is a decrease over time of the non-hydraulic additional braking moment, in particular a decrease over time of a generator braking moment, the target direction of rotation of pump motor 23 can be determined such that fluid conveyor device 22 can be used to pump brake fluid from fluid storage device 24 into the at least one wheel brake caliper 20. The target rotational speed and/or target duration of rotation can be determined as a function of a time difference of the non-hydraulic additional braking moment. In this way, it can be ensured that an overall braking moment specified by the driver can be reliably maintained despite a variation in the non-hydraulic additional braking moment, for example due to activation or deactivation of the generator.

In addition, control device 38 can be designed to execute the method steps indicated more precisely in the following. With regard to the design of control device 38 and the method steps that it can execute, reference is therefore made to the following Figure.

Fluid storage device 24 can be a storage chamber, in particular a springless storage chamber. Through a springless realization of the storage chamber, an additional reset spring on the storage piston can be omitted. However, it is to be noted that due to the advantageous applicability of fluid conveyor device 22, the transferring of brake fluid from the at least one wheel brake caliper 20 into fluid storage device 24 is also possible against a pressure present in fluid storage device 24. Therefore, the realization of fluid storage device 24 as a springless storage chamber or as a low-pressure storage device is merely optional.

Moreover, fluid storage device 24 can be connected to brake fluid reservoir 18 via a connecting line (not shown), for example from its rear side. Through the advantageous connection of fluid storage device 24 to brake fluid reservoir 18, when brake fluid is accepted (from the at least one wheel brake caliper 20) via a displacement of the storage piston of fluid storage device 24, brake fluid is pressed from the rear side of the storage piston into brake fluid reservoir 18. Fluid storage device 24 connected to brake fluid reservoir 18 is therefore capable of being designed without counterpressure. This reduces the pressure that is to be applied by fluid conveyor device 22 for the transfer of brake fluid from the at least one wheel brake caliper 20 into fluid storage device 24, and thus reduces the energy consumption of fluid conveyor device 22. The constructive requirements on fluid conveyor device 22 can also be reduced in this way.

Moreover, given the advantageous connection of fluid storage device 24 to brake fluid reservoir 18, the seal in the storage piston is loaded by brake fluid at both sides. The seal can therefore have very low friction. The costs for the seal of fluid storage device 24, which can for example be made of PTFE, can thus be reduced.

In a preferred specific embodiment, fluid storage device 24 is a membrane storage device not prestressed by gas. In this way, it can be prevented that, when the previously accommodated brake fluid is pumped into the at least one wheel brake cylinder 20 by fluid conveyor device 22, a partial vacuum will arise at the intake side of fluid conveyor device 22, causing the storage piston/storage chamber piston to be drawn forward up to its end stop. The use of the membrane is thus an advantageous possibility for reducing/avoiding a prestress pressure in fluid storage device 24 connected to brake fluid reservoir 18. The membrane is preferably designed such that at higher pressures it lies against the housing of the storage chamber without being damaged or destroyed. It is to be noted that the realization of fluid storage device 24 as a membrane storage device is advantageous even without the rear-side connection to brake fluid reservoir 18, because in this way lubrication in order to reduce the friction of the moved seal is no longer necessary.

However, the brake system is not limited to a fluid storage device 24 fashioned as a membrane storage device not prestressed by gas. As an alternative to such a realization of fluid storage device 24, the friction of the seal during the suctioning of the storage piston can also be reduced by installing a weaker spring as an alternative for the support of the piston movement.

Fluid storage device 24 can in particular be designed for a storage volume of 2 to 5 cm³, in particular 3 to 3.5 cm³. Thus, a space-saving component can also be used for fluid storage device 24.

It is to be noted that in the exemplary embodiments indicated above, leakage at the seal of fluid storage device 24 is excluded.

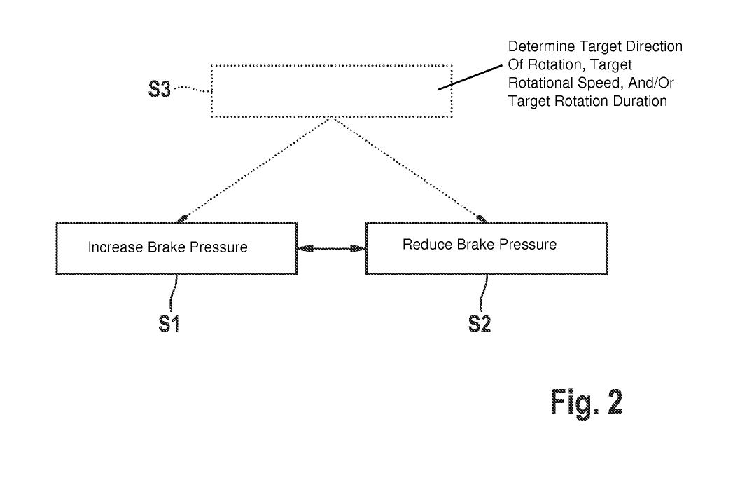

FIG. 2 shows a flow diagram representing a specific embodiment of the method for operating a brake system of a vehicle.

The method shown schematically in FIG. 2 can be carried out for example by the above-described brake system. However, it is to be noted that the practicability of the method is not limited to the use of this brake system.

In a method step S1, a brake pressure is increased in at least one wheel brake caliper hydraulically connected to a hydraulic cylinder. This takes place by controlling a pump motor of a fluid conveyor device that is connected at one side to the at least one wheel brake caliper and at another side to a fluid storage device. Here, the pump motor of the fluid conveyor device is controlled in a first direction of rotation, causing fluid to be pumped from the fluid storage device into the at least one wheel brake caliper.

In a method step S2, the brake pressure in the at least one wheel brake caliper is reduced. This takes place by controlling the pump motor of the fluid conveyor device in a second direction of rotation opposed to the first direction of rotation. By operating the pump motor in the second direction of rotation, brake fluid is pumped from the at least one wheel brake caliper into the fluid storage device.

The designation of method steps S1 and S2 does not determine any chronological sequence of their execution. Instead, method steps S1 and S2 can be carried out with arbitrarily many repetitions in different sequence.

Optionally, in a method step S3 a target direction of rotation, a target rotational speed, and/or a target duration of rotation of the pump motor of the fluid conveyor device can be determined taking into account a temporally varying non-hydraulic additional braking moment. Subsequently, the pump motor is operated in a manner corresponding to the determined target direction of rotation, target rotational speed, and/or target duration of rotation. This can also be described by saying that in method step S3 it is determined whether method step S1 or S2 is to be carried out, and which target rotational speed and/or target duration of rotation is to be maintained during the execution.

1-10. (canceled)

11. A brake system for a vehicle, comprising:
a master brake cylinder hydraulically connected to at least one wheel brake caliper; and
a fluid conveyor device by which a brake fluid can be transferred into the at least one wheel brake caliper and out of the at least one wheel brake caliper, wherein:
the fluid conveyor device includes a pump motor controllable in two directions of rotation,
the pump motor is controllable in such a way that the brake fluid can optionally be pumped by the fluid conveyor device either from a fluid storage device into the at least one wheel brake caliper or from the at least one wheel brake caliper into the fluid storage device,
the fluid conveyor device, in addition to an ESP device that includes an additional hydraulic unit and a second motor, is disposed on the brake system, and
the fluid conveyor device is hydraulically connected at one side to the fluid storage device and at another side, via an inlet and outlet control valve, to the ESP device and to the at least one wheel brake caliper.

12. The brake system as recited in claim 11, wherein the fluid conveyor device includes a gear pump.

13. The brake system as recited in claim 11, wherein the fluid conveyor device includes an internal gear pump.

14. The brake system as recited in claim 11, wherein the fluid storage device includes a springless storage chamber.

15. The brake system as recited in claim 11, wherein the fluid storage device is connected to a brake fluid reservoir via a connecting line.

16. The brake system as recited in claim 11, wherein the fluid storage device includes a membrane storage device not prestressed by gas.

17. The brake system as recited in claim 11, further comprising:
a control device for determining, taking into account a provided item of information relating to a temporally varying non-hydraulic additional braking moment, at least one of a target direction of rotation, a target rotational speed, and a target duration of rotation of the pump motor of the fluid conveyor device, wherein the control device outputs to the pump motor a pump control signal corresponding to at least one of the determined target direction of rotation, the determined target rotational speed, and the determined target duration of rotation.

18. A method for operating a brake system of a vehicle, comprising:
increasing a brake pressure in at least one wheel brake caliper hydraulically connected to a master brake cylinder by controlling, in a first direction of rotation, a pump motor of a fluid conveyor device that, in addition to an ESP device including a further hydraulic unit and a motor, is disposed on the brake system, and that is connected at one side via an inlet and outlet control valve to the ESP device and the at least one wheel brake caliper and at another side to a fluid storage device, causing a brake fluid to be pumped out of the fluid storage device into the at least one wheel brake caliper; and
reducing the brake pressure in the at least one wheel brake caliper by controlling the pump motor of the fluid conveyor device in a second direction of rotation, causing the brake fluid to be pumped from the at least one wheel brake caliper into the fluid storage device.

19. The method as recited in claim 18, further comprising:
determining at least one of a target direction of rotation, a target rotational speed, and a target duration of rotation of the pump motor of the fluid conveyor device, taking into account a temporally varying non-hydraulic additional braking moment; and
operating the pump motor of the fluid conveyor device in a manner corresponding to at least one of the determined target direction of rotation, the determined target rotational speed, and the determined target duration of rotation.
